(19) United States
(12) Patent Application Publication
(10) Pub. No.: US 2022/0358473 A1
(43) Pub. Date: Nov. 10, 2022

(54) REMITTANCE WITH RECIPIENT ALIAS

(71) Applicant: VISA INTERNATIONAL SERVICE ASSOCATION, San Francisco, CA (US)

(72) Inventors: Otto Williams, Dublin, CA (US); Harsha Naga, Dublin, CA (US)

(21) Appl. No.: 17/764,493

(22) PCT Filed: Nov. 6, 2020
(86) PCT No.: PCT/US2020/059529

§ 371 Date: Mar. 28, 2022

Related U.S. Application Data
(60) Provisional application No. 62/933,268, filed on Nov. 8, 2019.

(51) Int. Cl. G06Q 20/10; G06Q 20/40; G06Q 20/38

(52) U.S. Cl. CPC G06Q 20/10; G06Q 20/40; G06Q 20/385

(57) ABSTRACT

A method and system is provided for processing a remittance using a recipient alias. The method includes receiving, by a server computer associated with a processing network from an authenticating entity, transaction data for a transfer request. The transaction data includes a transfer amount and a recipient alias of a recipient. The method further includes querying a database using the recipient alias; holding the transfer request for a predetermined amount of time upon determining that the recipient alias is missing from the database; identifying a recipient account identifier in the database associated with the recipient alias during the predetermined amount of time; generating a transfer request message including at least the recipient account identifier and the transfer amount; and transmitting the transfer request message to an issuer computer of an issuer of the recipient account identifier, wherein the issuer notifies the recipient of the transfer amount.

### CROSS-REFERENCES TO RELATED APPLICATIONS

This application claims benefit under 35 USC § 119(e) to U.S. Provisional Patent Application No. 62/933,268 filed Nov. 8, 2019 and entitled “Unbanked Payouts”, the disclosure of which is incorporated by reference herein in their entirety for all purposes.

### BACKGROUND

Some people are “unbanked” and do not have access to or participate in transaction infrastructures such as bank accounts and credit cards. These people may thus be unable to participate in interactions with people who do have such accounts.

Embodiments address these and other issues, individually and collectively.

### BRIEF SUMMARY

One embodiment of the disclosure includes a method comprising receiving, by a server computer associated with a processing network from an authenticating entity, transaction data for a transfer request, wherein the transaction data includes a transfer amount and a recipient alias of a recipient; querying, by the server computer, a database using the recipient alias; holding, by the server computer, the transfer request for a predetermined amount of time upon determining that the recipient alias is missing from the database; identifying, by the server computer, a recipient account identifier in the database associated with the recipient alias during the predetermined amount of time; generating, by the server computer, a transfer request message including at least the recipient account identifier and the transfer amount; and transmitting, by the server computer, the transfer request message to an issuer computer of an issuer of the recipient account identifier, wherein the issuer notifies the recipient of the transfer amount.

Another embodiment of the disclosure can include a method comprising receiving, by a server computer, transaction data for a transfer request from a sender device of a sender, the transaction data comprising a transfer amount and a recipient alias of a recipient; determining, by the server computer, that a recipient account identifier is not associated with the recipient; transmitting, by the server computer, the transaction data to a processing network, wherein the processing network holds the transaction data for a predetermined amount of time; transmitting, by the server computer to an issuer computer, a request to assign the recipient account identifier to the recipient; performing, by the server computer, an authentication process with the recipient, wherein the issuer computer issues the recipient account identifier to the recipient upon successful completion of the authentication process, wherein the processing network obtains the recipient account identifier; and receiving, by the server computer from the processing network, a message indicating a status of the transfer request upon the processing network transmitting a transfer request message including at least the transfer amount and the recipient account identifier to the issuer computer.

Another embodiment of the disclosure can include a method comprising: receiving, by a server computer, transaction data for a transfer request from a sender device of a sender, the transaction data comprising a transfer amount, a recipient alias of a recipient, and a location of the recipient; querying, by the server computer, a database to locate an account identifier of a resource provider located within a predetermined distance of the location of the recipient; identifying, by the server computer, the resource provider and the account identifier of the resource provider based on the location of the recipient; generating, by the server computer, a transfer request message including the transfer amount, the recipient alias and the account identifier of the resource provider; transmitting, by the server computer, the transfer request message to an issuer computer; and receiving, by the server computer from the issuer computer, a message indicating a status of the transfer request upon the issuer computer receiving the transfer request message, wherein the recipient is notified of the transfer amount using the recipient alias, wherein the recipient receives the transfer amount from the resource provider.

Another embodiment of the disclosure can include a system comprising a first server computer associated with a processing network including a first processor and a first memory storing instructions that, when executed by the first processor, cause the first processor to: receive, from an authenticating entity, transaction data for a transfer request, wherein the transaction data includes a transfer amount and a recipient alias of a recipient; query a database using the recipient alias; hold the transfer request for a predetermined amount of time upon determining that the recipient alias is missing from the database; identify a recipient account identifier in the database associated with the recipient alias during the predetermined amount of time; generate a transfer request message including at least the recipient account identifier and the transfer amount; and transmit the transfer request message to an issuer computer of an issuer of the recipient account identifier, wherein the issuer notifies the recipient of the transfer amount.

Further details regarding embodiments of the invention can be found in the Detailed Description and the Figures.

### BRIEF DESCRIPTION OF THE DRAWINGS

FIG. 1 shows a sequence diagram of a first stage of an exemplary transaction process including digital issuance of account credentials, according to embodiments.

FIG. 2 shows a sequence diagram of a second stage of an exemplary transaction process including performing an authentication process with an entity, according to embodiments.

FIG. 3 shows a sequence diagram of a third stage of an exemplary transaction process including performing a transaction using the digitally issued account credentials, according to embodiments.

FIG. 4 shows a sequence diagram of another exemplary transaction process, according to embodiments.

FIG. 5 shows a block diagram of a system according to embodiments.

### DETAILED DESCRIPTION

Embodiments provide methods and systems for transferring funds from a sender to a recipient who may not have a financial account (e.g. a bank account, a credit card account, etc.) using essentially a recipient alias of the recipient (e.g. a recipient device identifier of a recipient device operated by the recipient).

Prior to discussing embodiments of the invention, some terms can be described in further detail.

A “sender” may include an individual. In some embodiments, a sender may be associated with one or more personal accounts and/or mobile devices. The sender may also be referred to as a cardholder, account holder, or consumer in some embodiments.

A “sender device” may be any suitable device that can be used by a sender. Sender devices may be in any suitable form. Some examples of sender devices include cellular phones, PDAs, personal computers (PCs), tablet computers, and the like. In some embodiments, where a sender device is a mobile device, the mobile device may include a display, a memory, a processor, a computer-readable medium, and any other suitable component. In other embodiments, a “sender device” may be a payment device such as credit, debit, or stored value card.

A “recipient” may include an individual. In some embodiments, a recipient may be associated with one or more personal accounts and/or mobile devices. The recipient may also be referred to as a cardholder, account holder, or consumer in some embodiments.

An “alias” may include a unique string of letters, symbols, and/or numbers associated with an entity. The alias may be used to contact or otherwise identify the entity. For example, the alias may include one or more of a mobile device number, an IMEI number of a mobile device, a SIM number, an email address, a social media moniker, etc.

A “recipient device” may be any suitable device that can be used by a recipient. Recipient devices may be in any suitable form. Some examples of recipient devices include cellular phones, PDAs, personal computers (PCs), tablet computers, and the like. In some embodiments, where a recipient device is a mobile communication device, the mobile device may include a display, a memory, a processor, a computer-readable medium, and any other suitable component, and may be associated with an recipient device identifier (e.g. IMEI number of the mobile device, a SIM number, or a mobile phone number). In other embodiments, a “recipient device” may be a payment device such as credit, debit, or stored value card.

A “mobile communication device” may be an example of a “communication device” that can be easily transported. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile communication devices include mobile phones (e.g. cellular phones), PDAs, tablet computers, net books, laptop computers, personal music players, hand-held specialized readers, etc. Further examples of mobile communication devices include wearable devices, such as smart watches, fitness bands, ankle bracelets, rings, earrings, etc., as well as automobiles with remote communication capabilities. In some embodiments, a mobile communication device can function as a payment device (e.g., a mobile communication device can store and be able to transmit payment credentials for a transaction).

A “payment device” may include any suitable device that may be used to conduct a financial transaction, such as to provide payment credentials to a merchant. The payment device may be a software object, a hardware object, or a physical object.

As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

A “resource provider” can be any suitable entity that provides resources (e.g., goods, services, access to secure data, access to locations, or the like) during a transaction. For example, a resource providing entity can be a merchant, a venue operator, a building owner, a governmental entity, etc. A “merchant” may typically be an entity that engages in transactions and can sell goods or services, or provide access to goods or services.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

An “originator processor” may be an entity that authenticates a recipient and/or a sender entity. In some embodiments, the originator processor may be an employer of the sender or an entity that pays or gives money to the sender. The originator processor may issue and/or manage an account for the sender. In some embodiments, the account may be issued in collaboration with a transaction processing network. The account may include a financial account that can accept and transfer funds. The originator processor may perform an authentication process with the sender and store the results of the authentication process associated with the account of the sender. The originator processor may also perform an authentication process with the recipient identified by the sender and store the results of the authentication process at a database accessible by third parties, such as a transaction processing network, and/or an issuer.

An “application” may be a computer program that is used for a specific purpose.

A “server computer” is typically a powerful computer or cluster of computers. For example, the server computer can be a large mainframe, a minicomputer cluster, or a group of servers functioning as a unit. In one example, the server computer may be a database server coupled to a Web server.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “transaction processing network” may include data processing subsystems, networks, server computers and operations used to support and deliver authorization services, exception file services, and clearing and settlement services. The payment processing network (130) may be any suitable network able to transmit and receive financial system transaction messages (e.g., ISO 8583 messages), and process original credit and debit card transactions. An exemplary payment processing system may include VisaNet™. Payment processing systems such as VisaNet™ are able to process credit card transactions, debit card transactions, and other types of commercial transactions.

“Transaction data” may be data that is associated with a transfer transaction. Transaction data may include a value such as a transfer amount, a date of a transfer, and a recipient alias. In some embodiments, the transaction data may include a location of the recipient.

“Credentials” may comprise any evidence of authority, rights, or entitlement to privileges. For example, “access credentials” may comprise permissions to access certain tangible or intangible assets, such as a building or a file. Examples of credentials may include passwords, passcodes, or secret messages. In another example, “payment credentials” may include any suitable information associated with and/or identifying an account (e.g., a payment account and/or payment device associated with the account). Such information may be directly related to the account or may be derived from information related to the account.

In embodiments of the invention, a sender may transfer funds to a recipient using a recipient alias of a recipient (e.g. a recipient device identifier of a recipient device of the recipient).

According to an exemplary embodiment, the sender may send a transfer request including a transfer amount and the recipient alias to a server computer. In some embodiments, the server computer may be associated with an employer of the sender, or an entity that maintains an account for the sender. The server computer may access a database to identify a recipient account information associated with the recipient using the recipient alias. However, as described above, the recipient may not have an account and the database may not include an entry for the recipient alias. The server computer may transmit the transfer request to a transaction processing network for warehousing (e.g. holding, storing). The server computer may then contact an issuer to issue a digital account identifier to the recipient. In some embodiments, the server computer may perform an authentication process with the recipient and may notify the issuer of the outcome of the authentication process. The issuer may issue the digital account identifier and store in the database. While warehousing the transfer request, the transaction processing network may continuously monitor the database for an entry storing the digital account identifier associated with the recipient alias. Upon detecting the digital account identifier associated with the recipient device in the database, the transaction processing network may retrieve the digital account identifier, and generate a transfer request message including the digital account identifier and the transfer amount. The transaction processing network may send the transfer request to the issuer, that then contacts the recipient for remitting the transfer amount to the recipient. The sender may be notified when the transfer is completed.

According to another exemplary embodiment, the sender may send a transfer request including a transfer amount, the recipient alias, and a location of the recipient to a server computer. In some embodiments, the server computer may be associated with an employer of the sender, or an entity that maintains an account for the sender. The server computer may access a database to identify an agent located within a predetermined distance of the recipient's location. The server computer may retrieve an identity and an account identifier of the agent from the database. The server computer may generate a modified transfer request including the transfer amount, the recipient alias and the account identifier of the agent to a transaction processing network. The transaction processing network may send the modified transfer request to the issuer, that then transfers the funds to the account identifier of the agent along with an indication that the funds are associated with the recipient alias. The agent may then contract the recipient using the recipient alias. The recipient may receive the funds from the agent. The sender may be notified when the transfer is completed.

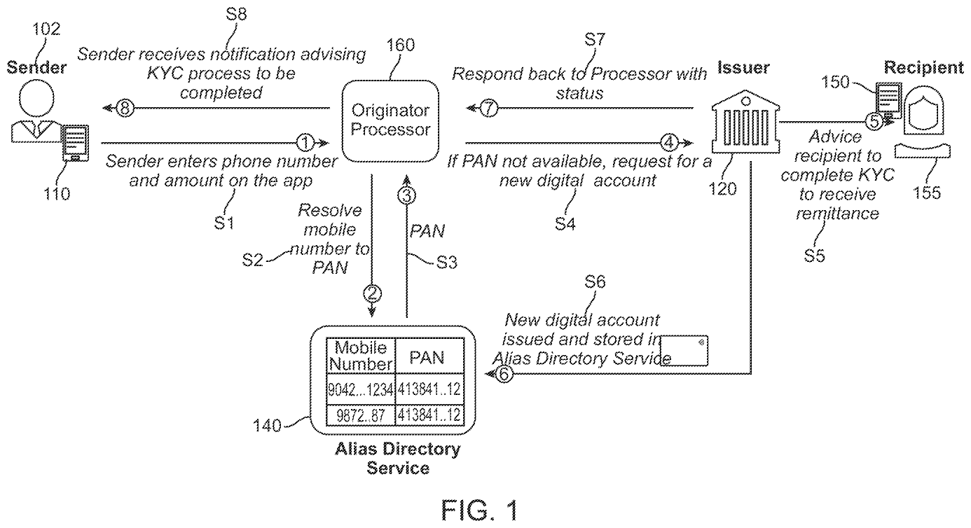

FIG. 1 shows a sequence diagram of a first stage of an exemplary transaction process (e.g. a first method for fund transfer using recipient alias) including digital issuance of account credentials, according to embodiments. The system can include a sender device 110 operated by a sender 102, an issuer 120 (e.g., operating an issuer computer), an originator processor 160 (e.g. operating a server computer), a database 140 (e.g. alias directory service), and a recipient device 150 operated by a recipient 155.

The sender 102 may wish to transfer funds (e.g. a remittance payment) to the recipient 155 using the recipient alias. The recipient alias may include an identifier for the recipient device 150 such as a mobile phone number, an email address, or any type of alias associated with the recipient device 150. In some embodiments, the recipient 155 may not have a bank account and the remittance may be sent using the recipient alias. According to various embodiments, the sender 102 and the recipient 155 may be located in different countries, and that the remittance payment may be sent internationally.

In step S1, the sender 102 can initiate a transfer request on the sender device 110 (e.g., a mobile phone, a laptop computer) to send money to the recipient 155. The sender device 110 can initiate the transfer with the originator processor 160. The sender device 110 may send to the originator processor 160 transaction data including a transfer amount, and an alias (e.g. a phone number or other recipient device identifier associated with the recipient device 150; an identification card number, an email address, a social media moniker associated with the recipient 155). For example, the sender 102 may activate an application associated with the originator processor 160 stored on the sender device 110.

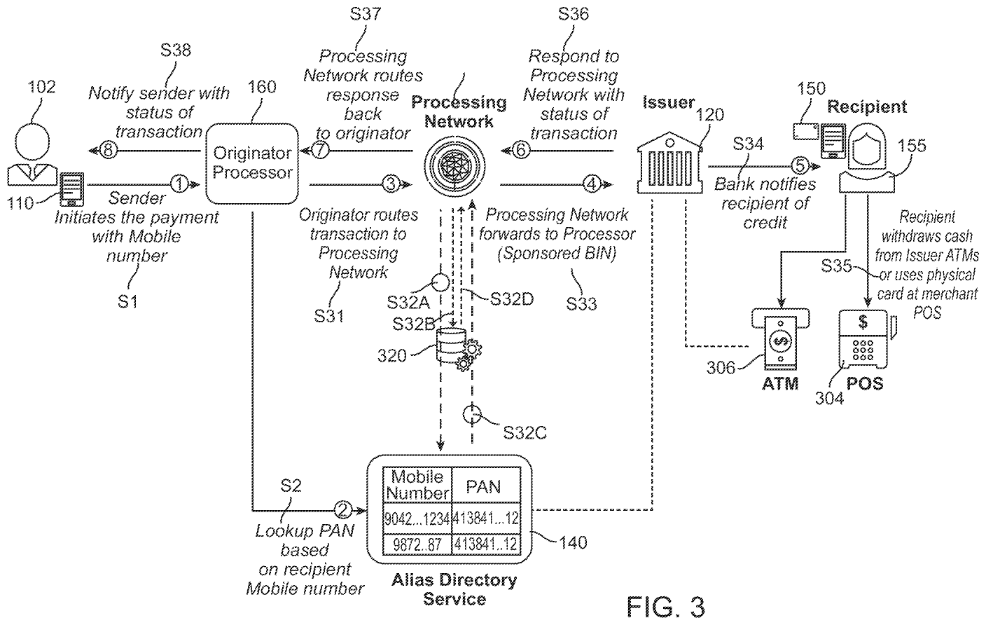

In some embodiments, the originator processor 160 may be an employer of the sender 102 or an entity that pays or otherwise deposits money to an account of the sender 102 (e.g. the sender 102 receives remuneration from the originator processor 160). The account of the sender may be managed by the originator processor 160. In some embodiments, the account of the sender may be managed by a processing network (e.g. processing network 302 illustrated in FIG. 3). For example, the originator processor 160 may deposit funds equal to or greater than the transfer amount to the account of the sender prior to the originator processor 160 receiving the transaction data.

In step S2, the originator processor 160 may query a database 140 (e.g. an alias directory) to determine if the database 140 includes an entry storing a recipient account identifier (e.g., a virtual primary account number (PAN)) mapped the recipient alias. If an alias mapping exists, the originator processor retrieves the recipient account identifier from the database 140 at step S3, and processes the transfer request using the recipient account identifier.

If the originator processor 160 determines that a recipient account identifier is not associated with the recipient alias at the database 140 (e.g. the recipient alias is missing from the database 140), the originator processor 160 transmits a request to an issuer 120 requesting the issuer 120 to issue (e.g. assign) a recipient account identifier to the recipient 155 at step S4. At this point, the originator processor 160 may also transmit the transaction data to a processing network for the processing network to warehouse (e.g. hold, store) the transaction data for a predetermined amount of time, until the issuer issues the recipient account identifier. This steps is discussed in greater detail below in connection with FIG. 3.

At step S5, the issuer 120 may contact the recipient 155 through the recipient device 150 to notify the recipient 155 of the transfer request. For example, the issuer 120 may send an SMS message to the phone number included in the transaction data. The notification can include a unique identifier assigned to the transfer request, which can uniquely identify the transfer request. In some embodiments, the unique identifier may be assigned by the originator processor 160 and transmitted to the sender device 110 of the sender 102. The sender 102 shares the unique identifier with the recipient 155. The recipient 155 may eventually receive the transfer amount using at least the unique identifier.

At step S5, the issuer 120 may further request the recipient 155 to complete an authentication process with the originator processor 160. At step S7, the issuer may also transmit a request to the originator processor 160 requesting the originator processor 160 to perform an authentication process with the recipient 155. In some embodiments, the issuer 120 may perform the authentication process with the recipient 155. At step S8, the originator processor 160 may inform the sender 102 that an authentication process will be performed with the recipient 155 before a recipient account identifier can be issued for the recipient 155 by the issuer 120.

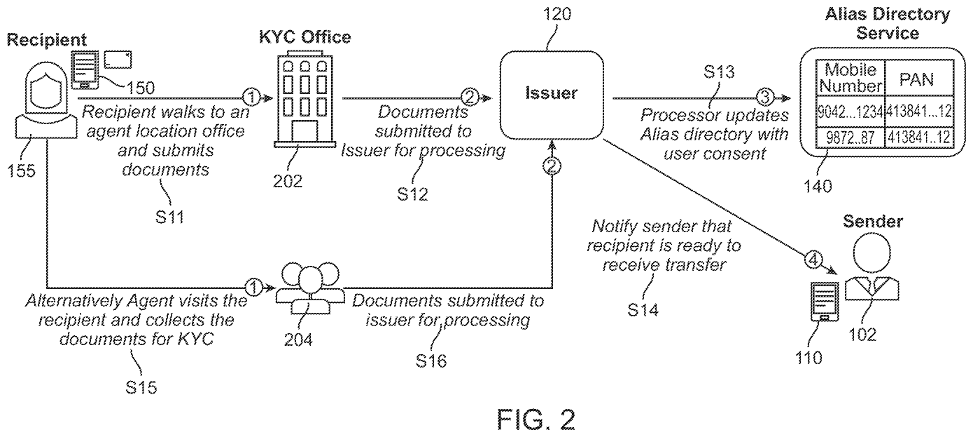

As will be discussed in greater detail below in connection with FIG. 2, the originator processor 160 may perform the authentication process with the recipient 155 and inform the issuer 120 of an outcome (e.g. result) of the authentication process. For example, the originator processor 160 may inform the issuer 120 of the successful completion of the authentication process with the recipient 155.

At step S6, the issuer 120 may issue the recipient account identifier to the recipient 155 upon successful completion of the authentication process, and store the recipient account identifier at the database 140 as being associated with the recipient alias. In some embodiments, the originator processor 160 and/or the issuer 120 may store additional information associated with the recipient 155 (e.g. the outcome of the authentication process, other information obtained during the course of the authentication process, identifying information such as name, address, national identification number, driver's license number of the recipient) at the database 140 as being associated with the recipient alias.

FIG. 2 shows a sequence diagram of a second stage of the exemplary transaction process (e.g. the first method for fund transfer using recipient alias) including performing an authentication process with an entity (e.g. the recipient 155), according to embodiments.

As discussed above, the issuer 120 may request the originator processor 160 to perform the authentication process with the recipient 155 prior to issuing (e.g.

assigning) the recipient account identifier to the recipient 155. The originator processor 160 may perform a variety of authentication processes in a variety of manners. The exemplary embodiments described below are for illustrative purposes only and should not be construed as limiting.

According to a first exemplary option, the originator processor 160 may request the recipient 155 to visit an authentication location 202 of the originator processor 160. At step S11, the recipient 155 may physically visit the authentication location 202. The recipient 155 may perform the authentication process with the originator processor 160 by, for example, answering questions, providing identification documents, providing bioinformatics, etc. After the authentication process is completed at the authentication location 202, results of the authentication process and/or documents obtained from the recipient 155 may be transmitted to the issuer 120 at S12. In some embodiments, the results of the authentication process and/or documents obtained from the recipient 155 may be uploaded and stored at the database 140.

According to a second exemplary option, the originator processor 160 may inform the recipient 155 that agents of the originator processor 160 will meet the recipient 155 to perform the authentication process. At step S15, the originator processor 160 may dispatch one or more agents 204 to a preferred location of the recipient 155. The recipient 155 may perform the authentication process with the one or more agents 204 by, for example, answering questions, providing identification documents, providing bioinformatics, etc. After the authentication process is completed by the one or more agents 204, results of the authentication process and/or documents obtained from the recipient 155 may be transmitted to the issuer 120 at S16. In some embodiments, the results of the authentication process and/or documents obtained from the recipient 155 may be uploaded and stored at the database 140.

Upon receiving results of the authentication process and/or documents obtained from the recipient 155 as part of the authentication process, the issuer 120 may issue the recipient account identifier to the recipient 155. For example, the issuer 120 may receive the results of the authentication process directly from the originator processor 160, or the issuer 120 may retrieve the results of the authentication process from the database 140. At step S13, the issuer 120 may store the recipient account identifier at the database 140 associated with the recipient alias. The issuer 120 and the originator processor 160 may have read and write privileges for accessing the database 140.

At step S14, the issuer 120 may notify the sender 102 that the recipient 155 is now ready to receive the transfer amount. For example, the issuer 120 may send an SMS message to the sender device 110 of the sender 102. According to various embodiments, the issuer 120 may also notify the originator processor 160 and/or the processing network when the recipient account identifier is issued.

FIG. 3 shows a sequence diagram of a third stage of the exemplary transaction process (e.g. the first method for fund transfer using recipient alias) including performing a transaction using the digitally issued account credentials, according to embodiments.

Steps S1 and S2 illustrated in FIG. 3 are identical to steps 51 and S2 of FIG. 1 and recaptured here to illustrate the how the third stage of the process (illustrated in FIG. 3) related to the first stage of the process (illustrated in FIG. 1). As described above in connection with FIG. 1, when the originator processor 160 determines that a recipient account identifier is not associated with the recipient alias at the database 140, the originator processor 160 transmits a request to an issuer 120 requesting the issuer 120 to issue (e.g. assign) a recipient account identifier for the recipient 155. The originator processor 160 also transmits the transaction data to a processing network 302 for the processing network 302 to warehouse (e.g. hold, store) the transaction data for a predetermined amount of time, until the issuer issues the recipient account identifier, at step S31.

At step S31, the processing network 302 (e.g. a server computer associated with the processing network) receives from the originator processor 160 (e.g. an authenticating entity) transaction data associated with a transfer request. According to some embodiments, the transaction data includes the transfer amount and the recipient alias (e.g. recipient device identifier of the recipient device 150 operated by the recipient 155).

At step S32A, the processing network 302 queries the database 140 using the recipient alias to identify a recipient account identifier. If the recipient identifier has not yet been issued by the issuer 120, at step 532B, the processing network warehouses (e.g. holds, stores) the transfer request for a predetermined amount of time upon determining that the recipient alias is missing from the database. According to various embodiments, the processing network 302 may store the transfer request including the transaction data (e.g. the transfer amount, the recipient alias) at a data warehouse 320. For example, the processing network 302 may warehouse the transfer request at the data warehouse 320 for up to 72 hours. If the recipient account identifier has not yet been issued by the issuer 120 at the end of the predetermined amount of time, the processing network 302 may return an error or transaction time out message to the originator processor 160.

The processing network 302 may continuously monitor the database 140 during the predetermined amount of time for an entry associated with the recipient alias. Once the issuer issues and stores the recipient account identifier at the database 140, the processing network 302 may identify the recipient account identifier in the database 140 associated with the recipient alias, and retrieve (e.g. obtain) the recipient account identifier from the database 140 during the predetermined amount of time.

In some embodiments, at step S32C, the processing network 302 may receive, from the database 140 via the data warehouse 320, an alert message indicating that an entry storing the recipient account identifier associated with the recipient alias is created in the database 140. The processing network 302 may also receive or retrieve (e.g. obtain) the recipient account identifier from the database 140 during the predetermined amount of time. According to various embodiments, the processing network 302 may have a read access (e.g. read-only access) to the database 140. At step 32D, the processing network 302 may retrieve (e.g. obtain) the transaction data (e.g. the transfer amount, the recipient alias) from the data warehouse 320.

At step S33, the processing network 302 may generate a transfer request message including at least the recipient account identifier and the transfer amount, and transmit the transfer request message to an issuer computer of the issuer 120 of the recipient account identifier.

At step S34, the issuer 120 may notify the recipient 155 of the transfer amount and may invite the recipient 155 to collect the funds at a terminal 306 (e.g. an ATM or a branch location) associated with the issuer 120. The recipient 155 may collect the funds by presenting at least the recipient alias. The recipient 155 may also present the unique identifier associate with the transfer request provided to the recipient 155, for example, by the sender 102. Alternatively, the issuer 120, upon issuing the recipient account identifier, may send a payment device (e.g. a payment card) to the recipient 155. The recipient 155 may collect the funds at a resource provider location by providing the payment device to a terminal (e.g. POS terminal) 304 associated with the resource provider.

At step S36, the processing network 302 may receive a status message indicating a status of the transfer request from the issuer computer of the issuer 120. At step S37, the processing network 302 may transmit the status message to the originator processor 160. At step S38, the originator processor 160 may notify the sender 102 of the status of the transfer request.

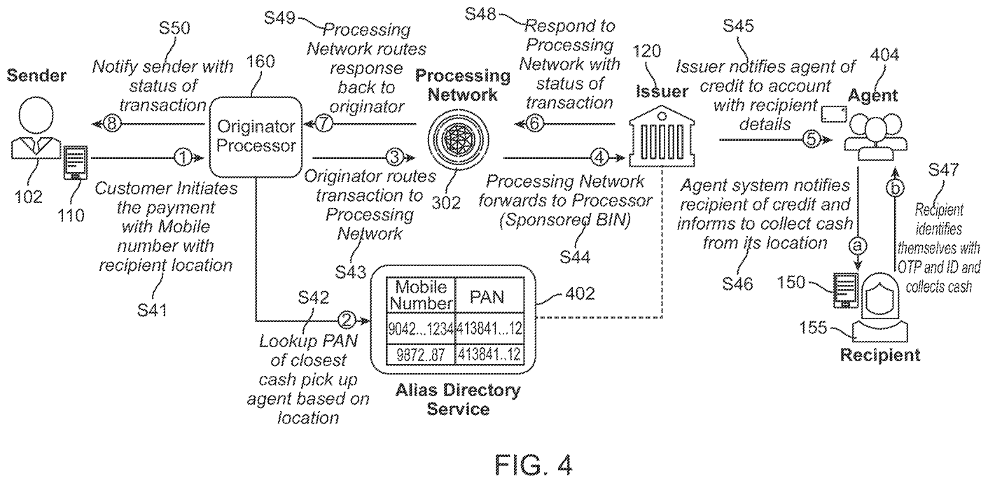

FIG. 4 shows a sequence diagram of another exemplary transaction process (e.g. a second method for fund transfer using recipient alias), according to embodiments. The system can include a sender device 110 operated by a sender 102, a processing network 302 (e.g. operating a first server computer), an issuer 120 (e.g., operating an issuer computer), an originator processor 160 (e.g. operating a second server computer), a database 402 (e.g. agent directory service), an agent 404 of the originator processor 106, and a recipient device 150 operated by a recipient 155.

The sender 102 may wish to transfer funds to the recipient 155 using the recipient alias (e.g. identifier for the recipient device 150 such as a mobile phone number).

In step S41, the sender 102 can initiate a transfer request on the sender device 110 (e.g., a mobile phone, a laptop computer) to send money to the recipient 155. The sender device 110 can initiate the transfer with the originator processor 160. The sender device 110 may send to the originator processor 160 transaction data including a transfer amount, a recipient alias (e.g. a phone number or other recipient device identifier) associated with the recipient 155, and location information of the recipient 155. For example, the sender 102 may activate an application associated with the originator processor 160 stored on the sender device 110. In some embodiments, the originator processor 160 may be an employer of the sender 102 or an entity that pays or otherwise deposits money to an account of the sender. The account of the sender may be managed by the originator processor 160. For example, the originator processor 160 may deposit funds equal to or greater than the transfer amount to the account of the sender prior to the originator processor 160 receiving the transaction data.

At step S42, the originator processor 160 may query a database 402 to locate an account identifier of an agent 404 (e.g. a resource provider) located within a predetermined distance of the location of the recipient 155. The agent 404 may be, for example, a bank, an ATM, a money exchange location, etc. associated with the originator processor 160. The originator processor 160 may identify the agent 404 at the database 402 based on the location of the recipient, and retrieve the account identifier of the agent 404.

At step S43, the originator processor 160 may generate a transfer request message including the transfer amount, the recipient alias and the account identifier of the identified agent 404 within a predetermined proximity of the recipient 155. The originator processor 160 may transmit the transfer request message to the processing network 302. At step S44, the processing network 302 may transmit the transfer request message to the issuer computer of the issuer 120.

At step S45, the issuer 120 may credit the transfer amount to the account associated with the account identifier of the agent 404, and notify the agent 404 of the credit along with the recipient alias. At step S46, The agent 404 may then inform the recipient 155 using the recipient alias, and request the recipient 155 to collect funds from the agent 404. At step S47, the recipient 155 visits the agent 404, and collects the funds by presenting at least the recipient alias. The recipient 155 may also present the unique identifier associate with the transfer request provided to the recipient 155, for example, by the sender 102.

At S48, the issuer computer may send a message indicating a status of the transfer request to the processing network 302. At step S49, the processing network 302 may transmit the status message to the originator processor 160. At step S50, the originator processor 160 notifies the sender 102 of the status of the transfer request.

For example, the status may indicate that the funds reached the agent, and that subsequent the funds have been received by the recipient 155.

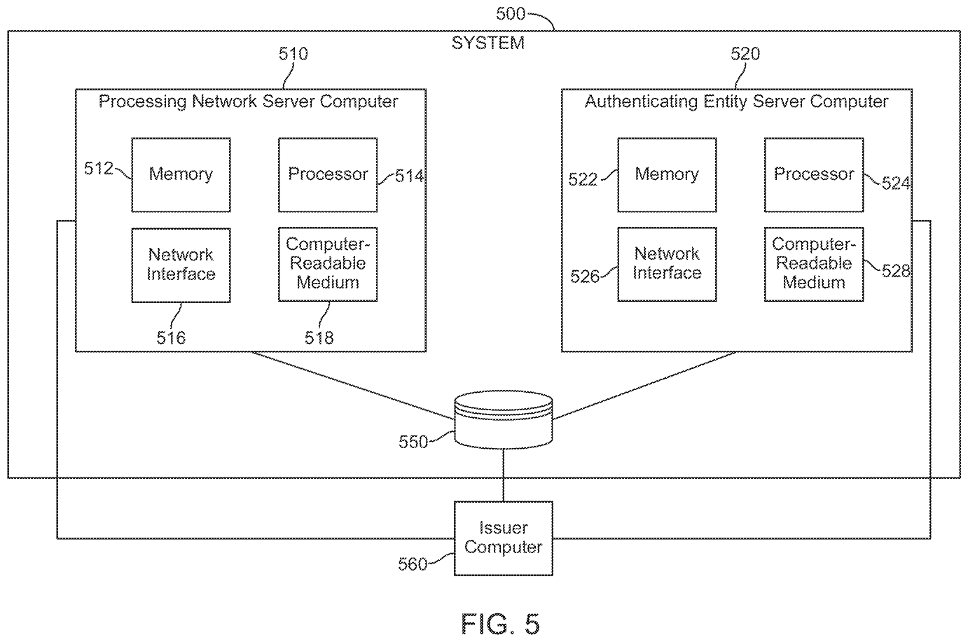

FIG. 5 shows a block diagram of a system 500 according to embodiments. The system may include a first server computer (e.g. a processing network server computer) 510, a second server computer (e.g. an authenticating entity computer, and originator processor computer) 520 and a database 550. The system 500 may be in communication with an issuer computer 560. The first server computer 502 may comprise a memory 512, a processor 514, a network interface 516, and a computer-readable medium 518. The second server computer 504 may comprise a memory 522, a processor 524, a network interface 526, and a computer-readable medium 528.

The memory 512, 522 may be implemented using any combination of any number of non-volatile memories (e.g., flash memory) and volatile memories (e.g., DRAM, SRAM), or any other non-transitory storage medium, or a combination of media.

The data processor 514, 524 may be implemented as one or more integrated circuits (e.g., one or more single core or multicore microprocessors and/or microcontrollers). The data processor 514, 524 may be used to control the operation of the server computer 510, 520, respectively. The data processor 514, 524 can execute a variety of programs in response to program code or computer-readable code stored in memory 512, 514. The processor 514, 524 may include functionality to maintain multiple concurrently executing programs or processes.

Network interface 516, 526 may be configured to connect to one or more communication networks to allow server computer 510, 520, respectively, to communicate with other entities such as the other one of the server computers 510, 520, the database 550, the issuer computer 560.

Computer-readable medium 518, 528 may comprise one or more non-transitory media for storage and/or transmission. Suitable media include, as examples, a random access memory (RAM), a read only memory (ROM), a magnetic medium such as a hard-drive, or an optical medium such as a CD (compact disk) or DVD (digital versatile disk), flash memory, and the like. The computer-readable medium 518, 528 may be any combination of such storage or transmission devices, and may comprise code for performing any of the methods described herein.

For example, the computer readable medium 518 may store instructions that, when executed by the processor 514, cause the processor 514 to receive, from an authenticating entity server computer 520, transaction data for a transfer request, wherein the transaction data includes a transfer amount and a recipient alias of a recipient; query the database 550 using the recipient alias; hold the transfer request for a predetermined amount of time upon determining that the recipient alias is missing from the database 550; identify a recipient account identifier in the database 550 associated with the recipient alias during the predetermined amount of time; generate a transfer request message including at least the recipient account identifier and the transfer amount; and transmit the transfer request message to the issuer computer 560 of an issuer of the recipient account identifier, wherein the issuer notifies the recipient of the transfer amount.

For example, the computer readable medium 528 may store instructions that, when executed by the processor 524, cause the processor 524 to receive the transaction data for the transfer request from a sender device; determine that the recipient account identifier is not associated with the recipient; transmit the transaction data to the first server computer 510 for holding; transmit, to the issuer computer 560, a request to assign the recipient account identifier to the recipient; perform an authentication process with the recipient, wherein the issuer computer 560 issues the recipient account identifier to the recipient upon successful completion of the authentication process, wherein the processing network obtains the recipient account identifier; and receive, from the first server computer 510, a message indicating a status of the transfer request upon the processing network transmitting a transfer request message including at least the transfer amount and the recipient account identifier to the issuer computer 560.

Embodiments allow a remittance processing using merely an alias for a recipient. The alias may be in form of a recipient device identifier, such as a mobile phone number. While some conventional system allow for sending funds to a recipient without using an account identifier, such systems require a lot of additional information about the recipient, such as the name, address, and an identification number of the recipient. In addition, conventional systems only allow for dispensing of the transferred funds at registered locations of the money transfer service, during the operating hours of the registered locations. In contrast, embodiments allow for remittance processing using a terminal (e.g. an ATM of a bank, a POS device at a merchant, etc.) without being restricted to operating hours of an entity.

In addition, embodiments allow for remittance processing without using a sender account of the sender. According to various embodiments, the remittance is initiated at an entity who may be under an obligation to pay the sender. The sender may initiate the remittance processing with the entity, using the funds from remuneration coming from the entity. Accordingly, the remittance processing may be performed even when the sender and/or the recipient does not have a financial account.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer associated with a processing network from an authenticating entity, transaction data for a transfer request, wherein the transaction data includes a transfer amount and a recipient alias of a recipient;
querying, by the server computer, a database using the recipient alias;
holding, by the server computer, the transfer request for a predetermined amount of time upon determining that the recipient alias is missing from the database;
identifying, by the server computer, a recipient account identifier in the database associated with the recipient alias during the predetermined amount of time;
generating, by the server computer, a transfer request message including at least the recipient account identifier and the transfer amount; and
transmitting, by the server computer, the transfer request message to an issuer computer of an issuer of the recipient account identifier, wherein the issuer notifies the recipient of the transfer amount.

2. The method of claim 1, further comprising:
receiving, by the server computer, a status message indicating a status of the transfer request from the issuer computer; and
transmitting, by the server computer, the status message to the authenticating entity, wherein the authenticating entity informs a sender of the transfer amount of the status of the transfer request.

3. The method of claim 1, wherein the recipient alias includes a recipient device identifier of a recipient device operated by the recipient.

4. The method of claim 1, further comprising:
prior to determining the recipient account identifier in the database associated with the recipient alias:
continuously monitoring, by the server computer, the database during the predetermined amount of time for an entry associated with the recipient alias, the entry storing the recipient account identifier.

5. The method of claim 1, further comprising:
prior to determining the recipient account identifier in the database associated with the recipient alias:
receiving, by the server computer, an alert message during the predetermined amount of time, wherein the alert message indicates that an entry storing the recipient account identifier associated with the recipient alias is created in the database.

6. A method comprising:
receiving, by a server computer, transaction data for a transfer request from a sender device of a sender, the transaction data comprising a transfer amount and a recipient alias of a recipient;
determining, by the server computer, that a recipient account identifier is not associated with the recipient;
transmitting, by the server computer, the transaction data to a processing network, wherein the processing network holds the transaction data for a predetermined amount of time;
transmitting, by the server computer to an issuer computer, a request to assign the recipient account identifier to the recipient;
performing, by the server computer, an authentication process with the recipient, wherein the issuer computer issues the recipient account identifier to the recipient upon successful completion of the authentication process, wherein the processing network obtains the recipient account identifier; and
receiving, by the server computer from the processing network, a message indicating a status of the transfer request upon the processing network transmitting a transfer request message including at least the transfer amount and the recipient account identifier to the issuer computer.

7. The method of claim 6, wherein determining that an account identifier is not associated with the recipient further comprising:
querying, by the server computer, a database using the recipient alias; and
identifying, by the server computer, that the recipient alias is missing from the database.

8. The method of claim 6, further comprising:
depositing, by the server computer, funds equal to or greater than the transfer amount to a sender account of the sender prior to the server computer receiving the transaction data.

9. The method of claim 6, further comprising:
receiving, by the server computer from the issuer computer, a request to complete the authentication process with the recipient; and
informing, by the server computer, the issuer computer that the authentication process is completed successfully.

10. A method comprising:
receiving, by a server computer, transaction data for a transfer request from a sender device of a sender, the transaction data comprising a transfer amount, a recipient alias of a recipient, and a location of the recipient;
querying, by the server computer, a database to locate an account identifier of a resource provider located within a predetermined distance of the location of the recipient;
identifying, by the server computer, the resource provider and the account identifier of the resource provider based on the location of the recipient;
generating, by the server computer, a transfer request message including the transfer amount, the recipient alias and the account identifier of the resource provider;
transmitting, by the server computer, the transfer request message to an issuer computer; and
receiving, by the server computer from the issuer computer, a message indicating a status of the transfer request upon the issuer computer receiving the transfer request message, wherein the recipient is notified of the transfer amount using the recipient alias, wherein the recipient receives the transfer amount from the resource provider.

11. The method of claim 10, further comprising:
depositing, by the server computer, funds equal to or greater than the transfer amount to a sender account of the sender prior to the server computer receiving the transaction data.

12. The method of claim 10, further comprising:
assigning, by the server computer, a unique identifier to the transfer request; and
transmitting, by the server computer, the unique identifier to the sender device of the sender, wherein the sender shares the unique identifier with the recipient, wherein the recipient receives the transfer amount from the resource provider using at least the unique identifier.

13. A system comprising:
a first server computer associated with a processing network including a first processor and a first memory storing instructions that, when executed by the first processor, cause the first processor to:
receive, from an authenticating entity, transaction data for a transfer request, wherein the transaction data includes a transfer amount and a recipient alias of a recipient;
query a database using the recipient alias;
hold the transfer request for a predetermined amount of time upon determining that the recipient alias is missing from the database;
identify a recipient account identifier in the database associated with the recipient alias during the predetermined amount of time;
generate a transfer request message including at least the recipient account identifier and the transfer amount; and
transmit the transfer request message to an issuer computer of an issuer of the recipient account identifier, wherein the issuer notifies the recipient of the transfer amount.

14. The system of claim 13, wherein the first memory stores further instructions that, when executed by the first processor, cause the first processor to:
transmit a status message indicating a status of the transfer request from the issuer computer to the authenticating entity, wherein the authenticating entity informs a sender of the transfer amount of the status of the transfer request.

15. The system of claim 13, wherein the first memory stores further instructions that, when executed by the first processor, cause the first processor to:
prior to determining the recipient account identifier in the database associated with the recipient alias:
continuously monitor the database during the predetermined amount of time for the recipient account identifier associated with the recipient alias.

16. The system of claim 13, wherein the first memory stores further instructions that, when executed by the first processor, cause the first processor to:
prior to determining the recipient account identifier in the database associated with the recipient alias:
receive an alert message indicating the recipient account identifier associated with the recipient alias is entered in the database.

17. The system of claim 13, further comprising:
a second server computer associated with the authenticating entity including a second processor and a second memory storing instructions that, when executed by the second processor, cause the second processor to:
receive the transaction data for the transfer request from a sender device;
determine that the recipient account identifier is not associated with the recipient;
transmit the transaction data to the first server computer for holding;
transmit, to the issuer computer, a request to assign the recipient account identifier to the recipient;
perform an authentication process with the recipient, wherein the issuer computer issues the recipient account identifier to the recipient upon successful completion of the authentication process, wherein the processing network obtains the recipient account identifier; and
receive, from the first server computer, a message indicating a status of the transfer request upon the processing network transmitting a transfer request message including at least the transfer amount and the recipient account identifier to the issuer computer.

18. The system of claim 17, wherein the second memory stores further instructions that, when executed by the second processor, cause the second processor to:
query the database using the recipient alias; and
identify that the recipient alias is missing from the database.

19. The system of claim 17, wherein the second memory stores further instructions that, when executed by the second processor, cause the second processor to:
receive, from the issuer computer, a request to complete the authentication process with the recipient; and
inform the issuer computer that the authentication process is completed successfully.

20. The system of claim 17, further comprising:
the database providing a read access to the first server computer, and a read and write access to the second server computer and the issuer computer.
